(19) United States
(12) Patent Application Publication
(10) Pub. No.: US 2007/0031803 A1
(43) Pub. Date: Feb. 8, 2007

(54) METHOD FOR RESPONDING TO READING COMPREHENSION QUESTIONS

(76) Inventor: Deborah L. Hirst, Burleson, TX (US)

Correspondence Address: Michael A. O'Neil;Michael A. O'Neil, P.C., Suite 820, 5949 Sherry Lane, Dallas, TX, 75225, US

(21) Appl. No.: 11/462,265

(22) Filed: Aug. 3, 2006

Related U.S. Application Data
(60) Provisional application No. 60/706,314, filed on Aug. 8, 2005.

(51) Int. Cl. G09B 7/00

(52) U.S. Cl. 434/323; 434/362

(57) ABSTRACT

Methods for responding to reading comprehension questions comprise steps providing a structured approach for reading a test passage and responding to test questions thereafter. A student following the method begins by reading and circling the directions. The student thereafter reads and underlines the passage title. Prior to or after reading the passage the student reads the questions following the passage to determine whether the question can be answered directly from the text or requires reasoning therefrom. The student then reads the provided passage either once or twice, underlining key words and text therein. The student then reads the answer choices to each question, eliminating obviously incorrect answers and thereafter selecting the best answer to the question.

### CROSS-REFERENCE TO RELATED APPLICATIONS

This application claims priority based on provisional patent application Ser. No. 60/706,314 filed Aug. 8, 2005, the entire content of which is incorporated herein by reference.

### TECHNICAL FIELD

This invention relates generally to test-taking strategies, and more particularly to methods for responding to reading comprehension questions providing a structured approach to reading and responding to reading comprehension questions.

### BACKGROUND AND SUMMARY OF THE INVENTION

Reading comprehension questions are found on the majority of skill assessment tests such as the national Skill Assessment Test, referred to as “SAT”, state specific skill assessment tests, and various other tests given in schools and classrooms across the country. Heretofore, various methods have been taught for responding to reading comprehension questions on tests and study exercises. Some methods recommend reading the questions first, others, the passage and then the questions. However, no method has successfully offered a systematic, sequential approach.

Most students try a given method but give up either because the method is too difficult to practice or yields unsuccessful results. As a result, reading comprehension is often difficult for many students and is often the reason why students score poorly on literacy portions of assessment tests. In addition to lower test scores, students fail to develop the necessary reading comprehension skills to be applied for future learning.

The present invention comprises methods for responding to reading comprehension questions which overcome the foregoing and other difficulties which have long since characterized the prior art. In accordance with the broader aspects of the invention, methods for responding to reading comprehension questions comprise steps providing a structured approach for reading a provided passage and responding to related questions thereafter. Each step is represented by a letter. The letters combine to form an acronym thereby enabling a student to remember the sequence of steps.

In accordance with a first embodiment of the invention a method for responding to reading comprehension questions comprises a structured sequence of steps which a student follows when answering reading comprehension questions beginning with reading and circling or “bubbling” the directions before a reading passage. Circling the directions calls the student's attention to details of what is to follow and in some cases specific details which require heightened attention. After circling the directions, the student underlines the passage title. Before reading the passage, the student reads each question following the passage to determine whether the question is a “book” question, meaning the answer can be found directly in the passage, or whether the question is a “brain” question, whereby the answer is not found directly in the passage but requires the student to form an answer from reading the passage. Each question is thereafter labeled accordingly.

After reading the questions, the student reads the passage two times, underlining key words and phrases therein. Before answering each question, the student reads all of the answer choices, eliminating any answers that are clearly wrong or make no sense. The student thereafter evaluates the remaining answers to select the best answer. While answering each question, the student notes the question number in the text where the answer is found and thereafter notes the corresponding line or paragraph number next to the question. After answering all of the questions, the student checks to ensure that all questions have been answered and that the answers marked on the answer sheet match the answers selected and thereafter completes a representation indicating that all steps have been performed.

A second embodiment of the invention is similar in many respects to the first embodiment. In accordance therewith a student first reads and circles the directions pertaining to a reading passage. The student then reads and underlines the passage title and key words in the passage. Next, the student reads the passage underlining key words and phrases therein. The student then reads each question pertaining to the passage and labels each question as “Book” or “Brain”.

The student then re-reads the passage again underlining key words and phrases. After re-reading the passage the student reads the questions pertaining to the passage and reads the answer choices for each question. The student eliminates answer choices which are clearly wrong or make no sense. The student then evaluates the remaining answer choices and determines the best possible answer. After determining the best possible answer for each of the questions the student checks to assure that all of the questions pertaining to the passage have been answered utilizing all of the components of the reading strategy.

The methods of the present invention are designed for use in conjunction with traditional methods for teaching reading fundamentals and are equally applicable to all reading comprehension questions whether on an assessment test, included in a classroom exercise, or for study assignments. Experimental results of the use of the methods of the present invention by students have been favorable. One hundred percent (100%) of the students practicing the methods of the present invention have passed the reading section of the Texas Assessment of Knowledge and Skills (TAKS) assessment test.

### BRIEF DESCRIPTION OF THE DRAWINGS

A more complete understanding of the present invention may be had by reference to the following Detailed Description when taken in connection with the accompanying Drawings, wherein:

FIG. 1 is a flowchart illustrating a method comprising a first embodiment of the present invention; and

FIG. 2 is a flowchart illustrating a method comprising a second embodiment of the present invention.

### DETAILED DESCRIPTION

### Introduction

The following examples describe a method for responding to reading comprehension questions incorporating the present invention.

### EXAMPLE

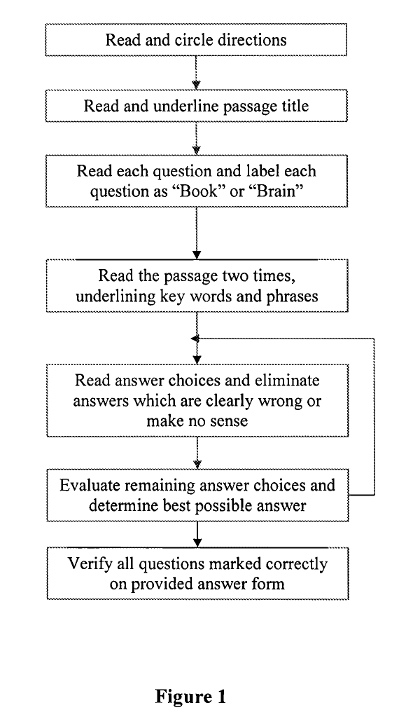

Referring now to the Drawings, and particularly to FIG. 1 thereof, there is shown the steps of the method for responding to reading comprehension questions of the present invention are illustrated. A provided passage used to test reading comprehension typically has a title and at least one corresponding question with multiple answer choices immediately following the passage. The first step in approaching a reading comprehension test is to read the directions for the test and thereafter circle, or “bubble” the directions. This first step is represented by the letter “B” for bubbling the directions. The directions are often ignored by the student; however, the directions are important because they inform the student of what is to come and in some cases alert a student to pay attention to certain items. Some standardized tests have one or more story passages per selection. The directions inform the student that the following passage is a one or multiple story passage. The student follows a different approach based on the number of stories in a selection and therefore needs to be aware of the number of stories in the passage in advance.

Next, the student reads and underlines the title of the test passage. This step is represented by the letter “U” for underline. Because the title often indicates what the passage is about, underlining the title enables a student to better understand the topic for the passage. The student then proceeds directly to the test questions following the passage. The student reads each question to determine and label each question as either a “book” or “brain” question. Consequently, this step is represented by the letters “BB.” A “book” question asks a question having an answer that can be found directly in the passage text. A “brain” question requires the student to form an answer from information gathered from the passage text. Once determined, the student denotes “bk” adjacent to the question for a “book” question and “br” adjacent to the question for a “brain” question. The foregoing step of determining the type of question further alerts the student as to information to look for while reading the passage text.

After the questions are labeled, the student reads through the passage a first time and thereafter re-reads the passage a second time. This step is represented by the letters “RR” for read and re-read. Students tend to attain more information by reading a passage two times. Reading the passage slowly, two times, enables the student to better obtain the meaning of the passage. During the first read, the student underlines key words and phrases thereby creating visual cues to important information. After reading the passage the first time the student makes a first mark below the passage. The student thereafter makes a second mark after reading the passage a second time.

After the second read of the passage, the student proceeds to answer the question. First, the student eliminates non-pertinent and nonsense answer choices. Once clearly wrong answer choices are eliminated, the student thereafter evaluates the remaining answer choices to select the most correct answer choice and marks the answer choice on the test answer sheet. Once the correct answer choice is selected, the student denotes the question number adjacent the relevant text in the passage underlining the text thereby affirming a student's answer choice and improving the student's confidence. The student further denotes the text location in line or paragraph number adjacent to the question thereby facilitating double-checking the answer choice once all questions have been answered. The foregoing process beginning with eliminating answer choices is repeated until all questions for the provided passage have been answered.

Once all questions have been answered for a given passage, the student goes back to verify that all questions have been answered and marked correctly on the test answer sheet. If time allows, the student may double-check the selected answer choices utilizing the notes marked adjacent to the questions and passage text.

After all of the foregoing steps are completed, the student makes a third mark below the first and second mark.

In order to prepare students to apply the method for responding to reading comprehension questions, an instructor prepares a sample passage with multiple questions and answer choices. The instructor thereafter teaches a group of students the method of the present invention by working through the sequence of steps described herein with them. Each step is practiced and reviewed by both the instructor and each student on a consistent basis until students become proficient in practicing the method. The instructor thereafter periodically practices the method with the students thereby maintaining each student's memory and skills.

In one embodiment of the present invention, the first, second and third mark form a circular figure commonly referred to as a “smiley face” having two parallel marks adjacent to one another a quarter circle therebelow. The parallel marks comprising first and second marks representing the “eyes” of the “smiley face.” The quarter-circular mark comprising the third mark represents the “mouth” of the “smiley face.”

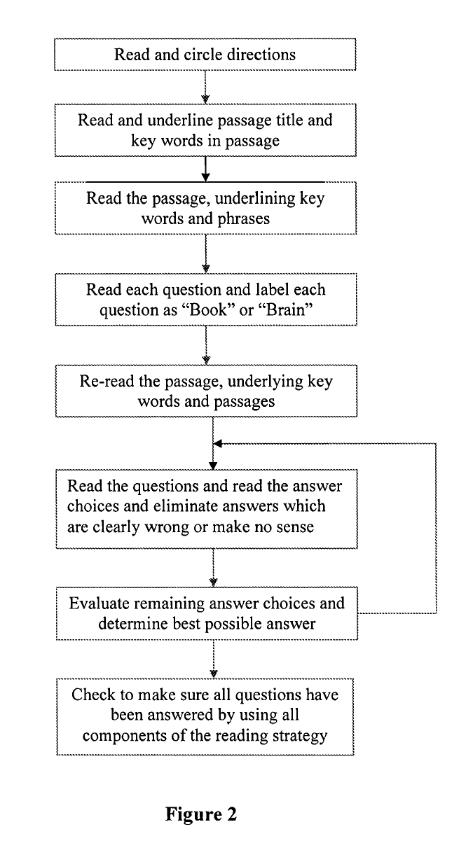

A second embodiment of the invention is illustrated in FIG. 2 and is similar in many respects to the first embodiment of the invention as described above. As in the first embodiment a student utilizing the second embodiment of the invention first reads and circles the directions pertaining to a particular reading passage. The student then reads and underlines the passage title and key words in the passage. Next, the student reads the passage underlining key words and phrases. The student then reads each question pertaining to the passage and labels the question as “Book” or “Brain”.

Having completed the foregoing steps the student then re-reads the passage again underlining key words and phrases. The student next reads the questions pertaining to the passage and reads the answers pertaining to each question. The student proceeds to eliminate answers which are either clearly wrong or make no sense. The student then evaluates the remaining answer choices and determines the best possible answer. Finally, the student checks to make sure that all of the questions have been answered using all of the components of the reading strategy.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method for responding to reading comprehension questions comprising the steps of:
providing a reading passage having a title and a plurality of questions following thereafter;
providing multiple answer choices for each of the questions;
providing a form for receiving answer choices made by the student;
providing directions before the passage;
reading the directions and thereafter circling the text comprising the directions;
reading and underlining the passage title;
reading each of the questions following the passage;
as to each question, determining whether the question is a book question answered directly from the passage text or a brain question not having a direct answer in the passage text and denoting the determination next to the question;
reading the passage and underlining key words and phrases therein;
re-reading the passage;
reading each question and eliminating at least one of the answer choices pertaining thereto; and
evaluating the remaining answer choices and selecting the answer choice providing the best answer to the question;
marking the selected answer choice on the provided answer form;
verifying all questions have been answered; and
verifying that the answers marked on the provided answer form correctly identify the answer choices selected.

2. The method for responding to reading comprehension questions according to claim 1 further comprising the steps:
providing an instructor;
providing a group of students desiring to prepare for answering reading comprehension questions;
providing a sample passage having sample questions and answer choices; and
the instructor leading the group of students through the steps according to claim 1.
